(19) United States
(12) Patent Application Publication
(10) Pub. No.: US 2026/0021620 A1
(43) Pub. Date: Jan. 22, 2026

(54) MULTILAYER POLYMER FILMS FORMED FROM POST-CONSUMER RECYCLING MATERIALS WITH IMPROVED MECHANICAL AND PHYSICAL PROPERTIES

(71) Applicant: Revolution Sustainable Solutions, Little Rock, AR (US)

(72) Inventors: Natarajan S. Ramesh, Midlothian, VA (US); Tim Shambro, West Monroe, LA (US)

(21) Appl. No.: 19/189,402

(22) Filed: Apr. 25, 2025

Related U.S. Application Data
(60) Provisional application No. 63/672,775, filed on Jul. 18, 2024.

(51) Int. Cl. B29C 48/21; B29C 48/10; B29K 23/00; B29K 105/26; B29K 507/04; B29L 7/00; B29L 9/00

(52) U.S. Cl. CPC B29C 48/21; B29C 48/10; B29K 2023/0625; B29K 2023/0633; B29K 2023/0641; B29K 2023/065; B29K 2105/26; B29K 2507/04; B29K 2995/0012; B29K 2995/0063; B29K 2995/0081; B29K 2995/0097; B29L 2007/002; B29L 2009/00

(57) ABSTRACT

A multi-layer film is described that has at least a skin and core layers, wherein the core layer comprises post-consumer recycled (PCR) polyethylene polymer.

### RELATED APPLICATIONS

This application claims benefit of U.S. Provisional Application Ser. No: 63/672,775 filed on Jul. 18, 2024, which is hereby incorporated by reference in its entirety.

### FIELD OF INVENTION

The present disclosure generally relates to multilayer polymer films formed from polymer blends that include post-consumer recycled materials and methods of forming such films and use of such films.

### BACKGROUND

Recycling programs, both voluntary and government mandated, have greatly increased the volume of available recycled materials over the last couple of decades. This is a trend that is sure to continue in the future. This is particularly true for plastics and other polymer materials. In 2021, approximately five billion pounds of post-consumer recycled (PCR) plastic materials were collected in the United States. This is an increase of over five percent compared to 2020. The latest information estimates that the PCR plastic market in 2023 in the United States is approximately 62.1 billion dollars and is projected to grow to 92.6 billion dollars by 2028.

In addition to government regulations, manufacturers may find economic incentives to use PCR plastic materials. As more and more PCR materials are collected, the price of such materials may fall below standard manufactured polymer resins, which will make PCR materials economically appealing. Finally, many corporations and organizations are engaging in good-governance and sustainability initiatives that encourage and promote the use of recycled materials.

This is true for both companies that manufacture products as well as companies that purchase products. Such initiatives will increase the use of PCR plastic materials in the manufacturing industry to satisfy internal policies or customers' policies.

To date, the one drawback of using PCR plastic materials in the manufacture of plastic products is that the incorporation of PCR plastics can degrade the physical and mechanical properties of the resulting product. For plastic products that rely on robust mechanical properties, it can be a significant technical hurdle to incorporate PCR plastic materials as an ingredient in the manufacturing process.

This disclosure describes and illustrates certain embodiments of multilayer plastic films suitable for use in polymer films that incorporate significant amounts of PCR plastic materials while maintaining the physical properties, such as tear strength and puncture strength, required for a quality film.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

In one embodiment, the invention the invention discloses a multi-layer film comprising at least two layers in which a skin layer that is a polyolefin having a density of from about 0.915 g/cc to 0.950 g/cc and a melt index of from about 0.5g to about 3 g/10 min at 190° C./2.16 kg. The second layer having post-consumer recycled linear low density polyethylene polymer having at least 0.25 melt flow index (M FI).

Other methods, features and/or advantages is, or will become, apparent upon examination of the following figures and detailed description. It is intended that all such additional methods, features, and advantages be included within this description and are protected by the accompanying claims.

### DETAILED DESCRIPTION

The apparatus, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such.

### Definitions

Unless otherwise defined, all technical and scientific terms used herein have the same meaning as commonly understood by one of ordinary skill in the art to which this invention pertains. In case of conflict, the present specification, including definitions, will control.

Unless otherwise specified, “a,” “an,” “the,” “one or more of,” and “at least one” are used interchangeably. The singular forms “a”, “an,” and “the” are inclusive of their plural forms.

The recitations of numerical ranges by endpoints include all numbers subsumed within that range (e.g., 0.5 to 5 includes 1, 1.5, 2, 2.75, 3, 3.80, 4, 5, etc.).

The term “about,” when referring to a value or to an amount of mass, weight, time, volume, concentration, or percentage is meant to encompass variations of ±1% from the specified amount. The term “about X wt. %” can be taken to means that the wt. % may vary within 1 wt. % of the X reference numeral unless otherwise specified. That is if X is 5 wt. %, and thus about 5 wt. % may encompass between 4 wt. % and 6 wt % unless otherwise described as encompassing a different range.

The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. The phrase “selected from the group consisting of” is meant to include mixtures of the listed group.

Moreover, the present disclosure also contemplates that in some aspects, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

According to one aspect of the invention the invention discloses a multi-layer film comprising at least two layers. The invention describes a skin layer comprising a polyolefin. Generally the skin layer of the multi-layer film has a density of from about 0.915 g/cc to 0.950 g/cc and a melt index of from about 0.5g to about 3 g/10 min at 190° C./2.16 kg. The invention describes a core layer. Importantly, the core layer may comprise a post-consumer recycled (PCR) material.

### Film Thickness

In general the multi-layer films according to the invention, whether they contain 2, 3, 5, 7 or more layers are of a thickness that is at least 20 mil to about 70 mils, or between 20 mils and 70 mils, or between 30 mils and 60 mils, or any single numerical value within the range of 20 mils and 70 mils, for example, 30 mils, 40 mils, or about 60 mils.

### Film Composition

The skin or in some cases the outer layer of the multi-layer film according to aspects of the invention has certain characteristics. Namely, a density of about 0.915 g/cc to 0.950 g/cc and a melt index of from about 0.5g to about 3 g/10 min at 190° C./2.16 kg. Preferably the skin layer is formed from a polyolefin. Preferably the skin layer is formed from a low-density polyethylene, a metallocene catalyzed polyethylene (mPE), a linear low-density polyethylene (LLDPE), a low-density polyethylene (LDPE), a medium-density polyethylene (M DPE), a high-density polyethylene (HDPE), a virgin polyolefin copolymers, or a blend of these materials. Of course, in some aspects of the invention, the skin layer of the multi-layer film may additionally include a post-consumer recycled polyethylene polymer, or a postindustrial recycled polyethylene polymer.

Another layer of the multi-layer film a core layer. The core layer includes a post-consumer recycled (PCR) low density polyethylene polymer. The core layer also has the property of having at least 0.25 melt flow index (M FI). Provided the core layer meets these characteristic, the type of recycled polymeric material is not particularly limited. The core may comprise a post-consumer recycled polyethylene polymer, or a postindustrial recycled polyethylene polymer. The recycled polyethylene polymer may also be characterized as a recycled metallocene catalyzed polyethylene (mPE), a recycled linear low-density polyethylene (LLDPE), a recycled low-density polyethylene (LDPE), a recycled medium-density polyethylene (M DPE), a recycled high-density polyethylene (HDPE).

In some aspects of the invention, the core layer comprises about 50% post-consumer recycled (PCR) content. The benefit of a core layer is the addition of between about 20% to 90% of PCR to the multi-layer film without effective the performance properties of film composes of at least once core layer and at least one skin layer. Note that the film as a whole may include between about 20% to 90% of PCR or the core layer of the film may include between about 20% to 90% of PCR since PCR may additionally be added to the skin layer.

In some aspects of the invention the multi-layer film comprise more than two layers. In some aspects, the multi-layer film comprise three layers, two skin layers with a core layer found between the two skin layers. In some aspects the multi-layer film includes five or seven layers, that alternate between skin and core layers provided a skin layer is both the outermost layer and the innermost layer. In a multi-layered film, the thickness of each layer is adjusted according o the needs of the user and do not need to necessarily be the same. The proviso is that the overall thickness of all layers should be between about 20 mils and about 70 mils.

According to one aspect of the invention, the overall thickness of films made according to the methods of the invention are greater than 70 mils and in fact are between about 60 mils and 120 mils, or between about 60 mils and 100 mils, or between 75 mils and 100 mils, or any single numerical value within this range. The same standard processes and advantages described for other films also characterize these thicker films.

### Film Formation

The coextruded multilayer film is made using the standard blown film process. The film is run on a 3-layer extrusion line that is fed by 3 extruders called A, B and C. Each extruder melts the polymers and pumps the molten plastic with additives into the co-extrusion die that is around 1800 mm in diameter at approximately 22.5 feet wide. The extrusion configuration has 3-layers with 25% A layer (inside skin), 50% B layer (core), 25% C layer (outside skin). Preferred extruded film thickness ranging from 20 mil to 60 mil and film thickness outside this range is possible as well. Extrusion profile temperatures range from 350 to 420° F. including the die. The run rate can vary between 2500 to 3200 lbs. per hour at 6 to 12 feet per minute. Typically, the standard layer ratio used is 30/40/30 but it was changed to 25/50/25 to get more PCR in blend. Typical blow-up ratio can be between 1 to 1.5.

### Film Formed Articles

Film can be used flat for pond liner application. It can also be converted into various forms and shapes depending on commercial needs and product applications. The film can be processed and adhesives can be applied or heat welded to make various shapes (bags, cylinders, spherical shapes etc.).

In some aspects of the invention, articles are formed from the films of the invention. In some aspects, the articles are pond liners.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art

### EXAMPLES

### Formation of Pond Liners With Post-Consumer Recycled (PCR) Multilayer Films

Characteristics of which are each described in Table 1. The 60 mil with 40% Mixed PCR (Core with 5% K 306 and 5% FM); the 40 mil with 50% Mixed PCR (Core), the 30 mil with 50% Mixed PCR (Core) are described Table 1. The 0% PCR 60-mil film is the control film for the 60-mil 40% mixed PCR film.

TABLE 1
film properties

| | | 30-mil | | 40-mil | | 60-mil | |
|---|---|---|---|---|---|---|---|
| | | 20% | 50% | 20% | 50% | | 40% |
| | Test | White | Mixed | White | Mixed | 0% | Mixed |
| Property | Method | PCR* | PCR* | PCR* | PCR* | PCR* | PCR* |
| Thickness, mils | ASTMD | 28 | 29 | 37 | 39 | 56 | 60 |
| | 5199 | | | | | | |
| Density, g/cc | ASTMD | | 0.942 | | 0.939 | | 0.942 |
| | 792 | | | | | | |
| % Carbon Black(CB) Content | ASTMD | 2.21 | 3.26 | 2.58 | 3.39 | 2.8 | 2.81 |
| | 4218 | | | | | | |
| Tensile Properties | | | | | | | |
| Yield Strength, MD/TD, ppi | ASTMD | 42/44 | 52/53 | 57/58 | 69/71 | 149/147 | 109/110 |
| Break Strength, MD/TD, ppi | 6693 | 112/108 | 19/114 | 143/147 | 155/150 | 247/244 | 231/235 |
| Yield Elongation(%), MD/TD | | 23/24 | 29/22 | 28/25 | 25/19 | 20/21 | 25/22 |
| Break Elongation(%), MD/TD | | 725/805 | 748/793 | 741/865 | 743/776 | 798/745 | 757/810 |
| Puncture Strength, lbf | ASTMD | 59 | 62.6 | 72 | 80 | 131 | 103 |
| | 4833 | | | | | | |
| Tear Resistance, MD/TD, lbf | ASTMD | 10/19 | 18.9/20.2 | 25/24 | 29/29 | 48/48 | 44/45 |
| | 1004 | | | | | | |

*PCR in core only

As can be seen in the Table that films comprising at least 50% PCR within the core structure are usable to form multi-layer films of a thickness between above 20 mils and 70 mils. Y et even further, the tensile, density and tear resistant properties of the multi-layer films according to the invention are on par with commercially available multi-layer films lacking the PCR of the invention.

We claim:

1. A multi-layer film comprising at least two layers,
the skin layer comprising a polyolefin having a density of from about 0.915 g/cc to 0.950 g/cc and a melt index of from about 0.5g to about 3 g/10 min at 190° C./2.16 kg, and
a core layer comprising post-consumer recycled (PCR) low density polyethylene polymer.

2. The multi-layer film of claim 1, wherein the outer skin layer of the multi-layer film comprises at least one of a low-density polyethylene, a metallocene catalyzed polyethylene (mPE), a linear low-density polyethylene (LLDPE), a low-density polyethylene (LDPE), a medium-density polyethylene (MDPE), a high-density polyethylene (HDPE), a virgin polyolefin copolymers, a post-consumer recycled polyethylene polymer, or a postindustrial recycled polyethylene polymer.

3. The multi-layer film of claim 1, wherein the film further comprises three layers, wherein first and third skin layers surround and enclose a second, core layer.

4. The multi-layer film of claim 3, wherein the second, core layer of post-consumer recycled linear low density polyethylene polymer having at least 0.25 melt flow index (M FI).

5. The multi-layer film of claim 3, wherein the second, core layer comprises about 50% post-consumer recycled (PCR) content.

6. The multi-layer film of claim 1, wherein the film further comprises five layers wherein first and third skin layers surround a second, core layer comprising post-consumer recycled linear low density polyethylene polymer and the third and fifth skin layers surround a fourth, core layer comprising post-consumer recycled linear low density polyethylene polymer.

7. The multi-layer film of claim 1, wherein the film further comprises seven layers wherein first and third skin layers surround a second, core layer comprising post-consumer recycled linear low density polyethylene polymer, the third and fifth skin layers surround a fourth, core layer comprising post-consumer recycled linear low density polyethylene polymer; and the fifth and seventh skin layers surround a sixth, core layer comprising post-consumer recycled linear low density polyethylene polymer.

8. The multi-layer film of claim 1, wherein the outer skin layer comprises a recycled linear low-density polyethylene (LLD PE), a low-density polyethylene (LDPE), a medium-density polyethylene (M D PE), a high-density polyethylene (HDPE), a post-consumer recycled polyethylene polymer, or a postindustrial recycled polyethylene polymer.

9. The multi-layer film of claim 8, wherein the overall post-consumer recycled content ranges from 20% to 90%

10. The multi-layer film of claim 3, wherein the overall film thickness ranges from about 20 mil to 70 mils.

11. An article formed from the multi-layer film of claim 11, wherein the article is a pond liner.

12. A method of making a multi-layer film comprising at least two layers, the film characterized by a skin layer comprising a polyolefin having a density of from about 0.915 g/cc to 0.950 g/cc and a melt index of from about 0.5g to about 3 g/10 min at 190° C./2.16 kg, and a core layer comprising about 50% post-consumer recycled (PCR) low density polyethylene polymer, and the method comprising a blown film process.
